(19) United States
(12) Patent Application Publication
(10) Pub. No.: US 2025/0250958 A1
(43) Pub. Date: Aug. 7, 2025

(54) A BUOYANT ACTUATOR AND A WAVE ENERGY CONVERSION SYSTEM INCORPORATING A BUOYANT ACTUATOR

(71) Applicant: CETO IP PTY LTD, North Fremantle (AU)

(72) Inventors: Phil Alexander KAIKO, North Fremantle (AU); Samuel Tobias NEILSON, North Fremantle (AU); Alexandre Frédéric Julien PICHARD, North Fremantle (AU); Jonathan Pierre FIÉVEZ, North Fremantle (AU)

(73) Assignee: CETO IP PTY LTD, North Fremantle (AU)

(21) Appl. No.: 18/853,173

(22) PCT Filed: Apr. 3, 2023
(86) PCT No.: PCT/AU2023/050260

§ 371 Date: Oct. 1, 2024

(30) Foreign Application Priority Data
Apr. 1, 2022 (AU) 2022900860

(51) Int. Cl. F03B 13/18; B63B 22/20

(52) U.S. Cl. CPC F03B 13/1885; B63B 22/20

(57) ABSTRACT

The present invention a buoyant actuator (11) for use in a system which converts wave motion to energy. The buoyant actuator (11) comprises a body (19) which presents an exterior surface. The body (19) provides at least one first tank (23) and at least one second tank (25), whereby an upper portion (21) of the body (19) is located above a fluid surface (12) of a fluid body (13) when the buoyant actuator is in a transportation position. When in the transportation position a volume of each of the at least one first tank (23) and the at least one second tank (25) above a waterline (112) of the buoyant actuator (11) is substantially empty.

### FIELD OF THE INVENTION

This invention relates generally to wave energy conversion. In particular, the invention relates to a buoyancy means which forms part of the apparatus for extracting energy from wave motion.

The invention relates to a buoyancy means and to a wave energy conversion system incorporating such a buoyancy means.

### BACKGROUND ART

It is known to translate wave motion to an energy conversion device operable in response to that wave motion, one example of which utilises a buoyancy means in the form of a buoyant actuator to translate wave motion into a reciprocating action at the energy conversion device.

In one form, the buoyant actuator is a large body having one or more ballast tanks incorporated therein. These ballast tanks are associated with one or more valves which are selectively moved between open and closed positions to regulate the buoyancy of the buoyant actuator, as well as its mass.

In an ideal operational condition, the buoyant actuator remains submerged or adjacent the surface of the water. This ensures a constant force exists in the coupling/tethers extending between the buoyant actuator and the energy conversion device. However, there are circumstances when the buoyant actuator is forcibly or desirably in an exposed condition wherein at least a portion of the buoyant actuator is above the water line. This may occur when the buoyant actuator is exposed to a high sea state, or when the buoyant actuator is being towed, such as required when installing or repairing the buoyant actuator.

When exposed to an aggressive sea state, such as those caused by adverse weather conditions, the buoyant actuator can be subject to extreme forces. Current buoyant actuators can be prone to damage or detachment when exposed to such conditions. Further, various components of the energy conversion device, the foundation to which the energy conversion device is anchored, and the coupling/tethers between the buoyant actuator and the energy conversion device can be subjected to excessive loadings which can lead to damage and loss of equipment.

To improve the survivability of the buoyant actuator during adverse weather conditions the buoyant actuator can be re-positioned closer to the seabed. However, in those buoyant actuator configurations in which there are multiple, angled couplings/tethers between the buoyant actuator and the energy conversion device, due to the angle of the couplings/tethers, the required downward/vertical force to move the buoyant actuator downward increases significantly. As the buoyant actuator moves closer to the seabed, the angle of the tethers increases, and the required force to offset the buoyancy of the buoyant actuator also continues to increase. In this circumstance the couplings/tethers and associated components experience excessive forces.

In other scenarios it is desirable to have a relatively buoyant, buoyant actuator. When the buoyant actuator is towed, such as when transporting the buoyant actuator for installation, repair or relocation, it is advantageous if drag on the buoyant actuator is minimised along with minimising its draft. This is best achieved by having as much of the buoyant actuator out of the water as possible. When the buoyant actuator has a large portion above the surface of the water, the capacity and equipment required to tow the buoyant actuator is significantly less, while also enabling movement in relatively shallow waters. Furthermore, the reduced drag caused by the water when the buoyant actuator is as buoyant as possible provides a safer towing environment.

The buoyancy of the buoyant actuator can be regulated by controlling the content of ballast tanks, requiring valves, pumps and associated control systems. However, these ballast control systems are seldom utilised as the buoyant actuator, once set in its operating position, rarely needs to be moved. The need to incorporate additional hardware and control systems not only adds expense, but these systems are subject to fail due to the harsh conditions to which they are exposed.

It is against this background that the present invention has been developed.

The preceding discussion of the background art is intended to facilitate an understanding of the present invention only. The discussion is not an acknowledgement or admission that any of the material referred to is or was part of the common general knowledge as at the priority date of the application.

### DISCLOSURE OF THE INVENTION

It is an object of this invention to provide a buoyant actuator which ameliorates, mitigates or overcomes, at least one disadvantage of the prior art, or which will at least provide the public with a practical choice.

According to a first aspect of the invention there is provided a buoyant actuator for use in a system which converts wave motion to energy, the buoyant actuator comprising a body presenting an exterior surface, an upper portion of the body providing at least one first tank and at least one second tank, whereby the upper portion of the body is located above a fluid surface of a fluid body when the buoyant actuator is in a transportation position.

Preferably each of the at least one first tank and the at least one second tank are substantially empty.

Preferably when the buoyant actuator is at its operational depth the body is located below the fluid surface of the fluid body, and each of the at least one first tank contains a further fluid, such as air, less dense that the fluid of the fluid body and each of the at least one second tank is full of the fluid of the fluid body. Preferably each of the at least one first tank is substantially empty. More than half of the at least one first tank may contain a gas less dense than the fluid body. Preferably the at least one first tank may be substantially full of the less dense further fluid.

Preferably when the buoyant actuator is in a survival state, the body is located below its operational depth, wherein each of the at least one first tank and the at least one second tank are full of the fluid.

In one embodiment the buoyant actuator incorporates an energy conversion device.

In another embodiment the buoyant actuator is adapted to be connected to an energy conversion device.

According to a second aspect of the invention there is provided a buoyant actuator for use in a system which converts wave motion to energy, the buoyant actuator comprising:
a body presenting an exterior surface, an upper portion of the body providing at least one first tank and at least one second tank, whereby the upper portion of the body is adapted to be located above a fluid surface of a fluid body when at least a portion of each of the at least one first tank and the at least one second tank contain a gas less dense than the fluid body;
the at least one first tank has at least one upper opening in an upper region thereof, and at least one lower opening located in a lower region thereof, wherein at least one of the upper opening or the lower opening has a valve to regulate the flow of fluid through the at least one first tank, wherein selective operation of the valve causes fluid to pass between the at least one upper opening, the first tank and the at least one lower opening;
the at least one second tank has at least one upper opening in an upper region thereof, and at least one lower opening located in a lower region thereof, such that as the buoyant actuator is repositioned relative to the fluid surface the fluid is able to pass between the at least one upper opening, the second tank and the at least one lower opening, wherein each of the at least one upper opening and the at least one lower opening are permanently open allowing for the free flow of fluid into and out of the at least one second tank.

Preferably when the buoyant actuator is at its operational depth the body is located below the fluid surface of the fluid body, and each of the at least one first tank contains a gas less dense that the fluid body and each of the at least one second tank is full.

Preferably each of the at least one first tank is substantially empty.

Preferably when the buoyant actuator is in a survival state, the body is located below its operational depth, wherein each of the at least one first tank and the at least one second tank are full.

Preferably each of the at least one upper opening of the first tanks and each of the at least one lower opening have the valve.

The at least one first tank and/or the at least one second tank may be accommodated within the hollow body.

An outer section of the at least one first tank and/or the at least one second tank may be provided by the external surface of the body.

The at least one body comprises one or more further tanks wherein the one or more further tanks may be located below the upper portion of the body.

The at least one body comprises one or more further tanks wherein the one or more further tanks may be located below the at least one first tank and the at least one second tank.

The one or more further tanks may be used for a variety of functions and may include one or more of the following:
a sealed tank to provide the body with the desired positive buoyancy regardless of whether the at least one first tank and/or the at least one second tank is empty, full or partially full;
a ballast tank having means to vary the ballast and control the buoyancy of the body.

Preferably, the buoyant actuator is configured to maintain a substantially taut connection between the body and the tether regardless of whether the first tank and second tank are full, empty, or therebetween. That is, the natural buoyancy of the buoyant actuator is positively buoyant.

In an embodiment the hollow body of the buoyant actuator is associated with a coupling means, the coupling means may incorporate an energy conversion device.

In another embodiment the hollow body of the buoyant actuator is associated with a coupling means for operatively connecting the buoyant actuator to an energy conversion device.

The hollow body of the buoyant actuator may be associated with an anchoring means for operatively connecting the buoyant actuator relative to the seabed, or other permanent structure.

The anchoring means may be in the form of one or more tethers extending partially or entirely between the buoyant actuator and the seabed or other permanent structure. The one or more tethers may be angled relative to the buoyant actuator. The one or more tethers may be angled relative to the seabed/other permanent structure. The one or more tethers may be connected to an energy conversion device which is connected to the hollow body.

The at least one first tank may have a portion thereof which is in an elevated position relative to the at least one second tank when the buoyant actuator is in its operative state. This assists in draining of the first tank while maintaining a minimum tension on the tethers.

According to a third aspect of the invention there is provided a buoyant actuator comprising:
a hollow body presenting an exterior surface, the hollow body being adapted to be continuously located below a fluid surface during operation;
the hollow body providing a first tank and a second tank in an upper portion thereof, the second tank having at least one opening in an upper portion, and at least one opening in a lowermost portion, wherein both openings of the second tank are permanently open such that fluid may pass through the openings and the second tank as the buoyant actuator is repositioned relative to the fluid surface;
the upper portion of the body being located above the fluid surface when each of the at least one first tank and the at least one second tank are at least partially empty;
an anchoring means associated with the hollow body for operatively connecting the buoyant actuator relative to the seabed, or other permanent structure.

The first tank may have at least a portion thereof in an elevated position relative to the second tank when the buoyant actuator is in its operative state.

According to a fourth aspect of the invention there is provided a buoyant actuator for use with a system which converts wave motion to energy, the buoyant actuator comprising a body presenting an exterior surface, the body comprises an upper portion which provides at least one first tank and at least one second tank, wherein the upper portion of the body is located above each further ballast tank housed in the body.

According to a fifth aspect of the invention there is provided a buoyant actuator for use with a system which converts wave motion to energy, the buoyant actuator comprising
a body presenting an exterior surface, wherein in operation the body is adapted to be located below a surface of a fluid body, an upper portion of the body provides at least one first tank and at least one second tank, wherein the upper portion of the body is located above the fluid surface when each of the at least one first tank and the at least one second tank are at least partially empty;
the at least one first tank has a portion thereof which is in an elevated position relative to the at least one second tank when the buoyant actuator is in its operative state,
the at least one first tank has at least one upper opening in an upper region thereof, and at least one lower opening located in a lowermost region thereof, wherein at least one of the upper opening or the lower opening has a valve to regulate the flow of fluid through the at least one first tank, wherein selective operation of the valve causes fluid to pass between the at least one upper opening, the first tank and the at least one lower opening;
the at least one second tank has at least one upper opening in an upper region thereof, and at least one lower opening located in a lowermost region thereof, such that fluid is able to pass through the at least one upper opening, the second tank and the at least one lower opening as the buoyant actuator is repositioned relative to the fluid surface, wherein each of the at least one upper opening and the at least one lower opening allow for the free flow of fluid into and out of the at least one second tank.

Preferably the upper portion of the body is located above the fluid surface when each of the at least one first tank and the at least one second tank are substantially empty, or are at least more than half empty.

According to a sixth aspect of the invention there is provided a buoyant actuator comprising a hollow body presenting an exterior surface, the hollow body being adapted to be continuously located below a fluid surface during operation, the hollow body being configured to provide one or more ballast tanks in an upper section thereof, wherein at least one of the one or more ballast tanks is self-filling and self-draining.

The one or more ballast tanks may be self-filling as the upper section of the hollow body moves below the fluid surface.

The one or more ballast tanks may be self-draining when the upper section of the hollow body moves above the fluid surface.

Preferably the buoyant actuator comprises one or more ballast chambers below the one or more ballast tanks.

Preferably, the upper section incorporates an uppermost surface of the exposed surface of the hollow body.

According to a seventh aspect of the invention there is provided a buoyant actuator comprising a hollow body presenting an exterior surface, the hollow body being adapted to be continuously located below a water surface during operation, one or more buoyant tanks accommodated within an upper section of the hollow body, wherein one or more of the buoyant tanks is self-filling and self-emptying according to the position of the hollow body with respect to the fluid surface.

According to an eighth aspect of the invention there is provided a buoyant actuator comprising a body presenting an exterior surface, the body being adapted to be continuously located below a fluid surface when in an operative state, the body being configured to provide one or more ballast tanks, wherein at least one of the one or more ballast tanks is capable of self-filling and self-draining.

Preferably the buoyant actuator has a waterline datum line, the waterline of the buoyant actuator being the level where the fluid surface reaches on the buoyant actuator when the buoyant actuator is in the fluid but with substantially no additional external downward force being applied to the buoyant actuator.

The degree to which the one or more ballast tanks drains will depend on the configuration of the one or more ballast tanks relative to the waterline of the buoyancy actuator.

The waterline is a datum line of reference of the buoyant actuator based on its natural buoyancy and is not a visible feature of the buoyant actuator. The waterline of the buoyant actuator is the level where the fluid surface reaches on the buoyant actuator when the buoyant actuator is in the fluid but with substantially no additional external downward force being applied to the buoyant actuator.

Preferably the one or more ballast tanks may be in an upper section of the body. The one or more ballast tanks may be formed as part of the body and/or may be fitted to an interior or exterior of the body. Where there is more than one ballast tank, the ballast tanks may be in the form of a combination of these configurations.

Preferably the one or more ballast tanks has at least one upper opening in an upper region thereof. The at least one upper opening may be in fluid communication with the environment external the body.

Preferably the one or more ballast tanks has at least one lower opening located in a lower region. The at least one lower opening may be located below the at least one upper opening when being transported or when in operation. The at least one lower opening may be in fluid communication with the environment external the body.

In one aspect of the invention wherein the buoyant actuator is in a transport state, there is substantially no downward force restraining the buoyant actuator, the one or more ballast tanks are above the fluid surface, and the one or more ballast tanks are substantially empty. In this configuration the one or more ballast tanks are located above the waterline of the buoyant actuator.

In another aspect of the invention wherein the buoyant actuator is in a transport state, there is substantially no downward force restraining the buoyant actuator, and a volume of the one or more ballast tanks above the waterline is substantially empty.

According to another embodiment of the invention, when the buoyant actuator is in a transport state there is minimal downward force restraining the buoyant actuator, a large portion of each of the one or more ballast tanks is above the fluid surface, and the large portion of each of the one or more ballast tanks is empty.

A volume of the one or more ballast tanks located above the waterline of the buoyant actuator may be substantially empty.

In one aspect of the invention the large portion of each of the one or more ballast tanks is that portion of the one or more ballast tanks above a waterline of the buoyant actuator.

In another aspect of the invention the large portion is greater than 50% of the volume of each of the one or more ballast tanks.

Preferably the buoyant actuator is in an operative state or a survival state where there is a downward force exerted on the buoyant actuator to maintain the buoyant actuator in a position below the fluid surface, and one or more of the one or more ballast tanks are full.

The body may provide a plurality of ballast tanks, wherein one or more of the plurality of ballast tanks have an opening therebetween

Preferably the body provides a plurality of ballast tanks incorporating a set of first tanks comprising one or more ballast tanks, and a set of second tanks, comprising one or more ballast tanks.

Preferably the at least one upper opening of the at least one first tank has a valve to regulate the flow of fluid through the at least one first tank, whereupon selective operation of the valve causes fluid to pass through the at least one upper opening, selectively enabling the at least one first tank to self-fill and self-drain based on the state of the valve and the position of the buoyant actuator relative to the fluid surface.

Preferably the at least one lower opening of the at least one first tank has a valve to regulate the flow of fluid through the at least one first tank, whereupon selective operation of the valve causes fluid to pass through the at least one lower opening, selectively enabling the at least one first tank to self-fill and self-drain based on the state of the valve and the position of the buoyant actuator relative to the fluid surface.

Preferably the at least one upper opening of the at least one first tank and the at least one lower opening of the at least one first tank each have a valve to regulate the flow of fluid through the at least one first tank, whereupon selective operation of the valve allows fluid to enter the at least one first tank when at least the lower region of the at least one first tank is below the fluid surface, and to drain from the at least one first tank when at least the uppermost region of the at least one first tank is above the fluid surface, such that the at least one first tank is capable of self-filling and self-draining based on the state of each valve and the position of the buoyant actuator relative to the fluid surface.

Preferably the at least one first tank incorporates a compressible medium wherein the compressible medium is exposed to the pressure of the fluid entering the at least one first tank.

In an alternative embodiment, the at least one first tank is formed from a compressible medium wherein the compressible medium is exposed to the pressure of the fluid when the buoyant actuator is placed in the fluid. In such an embodiment the compressible medium may be secured relative to an inner surface or an external surface of the body.

The compressible medium may be pre-pressurised.

The compressible medium may be pre-pressurised such that the volume of the compressible medium does not begin to reduce in volume until a certain depth is reached.

The compressible medium may be selected from: a sealed bladder, an inflatable elastic body (e.g. a boat fender), a compressible foam, a flexible membrane dividing the tank or a combination of each. The flexible member may seal a portion of the tank from the outlet/inlet and react to changes in pressure as the buoyant actuator changes positions relative to the fluid surface.

Preferably both of, or at least one of the at least one upper opening and the at least one lower opening of each of the one or more ballast tank has a valve to regulate the flow of fluid through the one or more ballast tanks, whereupon selective operation of the valve(s) allows fluid to enter the one or more ballast tanks when at least the lower region of the one or more ballast tanks is below the fluid surface, and to drain from the one or more ballast tanks when at least the uppermost region of the one or more ballast tanks is above the fluid surface, such that the one or more ballast tanks is capable of self-filling and self-draining based on the state of each valve and the position of the buoyant actuator relative to the fluid surface.

Preferably the buoyant actuator is in a transport state where there is substantially no downward force restraining the buoyant actuator, each valve is closed and the large portion of the at least one first tank is substantially empty.

Preferably the buoyant actuator is in an operative state where there is a downward force exerted on the buoyant actuator to maintain the buoyant actuator in a position below the fluid surface, each valve is closed and the large portion of the at least one first tank is substantially empty.

The buoyant actuator may comprise or be coupled to one or more tethers which are adapted to secure the buoyant actuator to the sea bed or other structure. The tethers may be retracted or extended relative to the body to change the depth at which the body is positioned in the fluid body.

Preferably the buoyant actuator is in a survival state with the tethers retracted further than in the operative state, so that the buoyant actuator is in a position located below the operative state, each valve is open and the at least one first tank is full.

Preferably the at least one second tank is self-filling as the upper section of the body moves below the fluid surface. Preferably the at least one second tank is self-draining when the upper section of the body moves above the fluid surface.

According to an ninth aspect of the invention there is provided a buoyant actuator for use in a system which converts wave motion to energy, the buoyant actuator comprising a body presenting an exterior surface, an upper portion of the body providing one or more tanks, whereby the upper portion of the body is located above a fluid surface of a fluid body when a volume of the one or more tanks above a waterline of the buoyant actuator is substantially empty and the buoyant actuator is relatively unrestrained and floating at the fluid surface of the fluid body wherein the one or more tanks have at least one upper opening in an upper region thereof, and at least one lower opening located in a lower region thereof, wherein the at least one upper opening and the at least one lower opening enable the filling of the one or more tanks by the action of gravity (i.e.no pumps required) when the one or more tanks are positioned below the fluid surface, while also enabling the draining of the one or more tanks by the action of gravity when the buoyant actuator is floating at the surface of the fluid body.

Preferably at least one of the upper opening or the lower opening has a valve to regulate the flow of fluid through the openings, whereas the volume of the one or more tanks remains empty when positioned below the fluid surface with the valve closed.

Preferably the at least one or more tanks includes at least one first tank and at least one second tank, wherein each of the upper opening or both of the upper opening and the lower opening of the at least one second tank has a valve to regulate the flow of fluid through the openings, whereas the volume of the at least one second tank remains empty when positioned below the fluid surface with the valve closed.

According to a tenth aspect of the invention there is provided a buoyant actuator for use in a system which converts wave motion to energy, the buoyant actuator comprising a body presenting an exterior surface, the body comprising one or more tanks, the one or more tanks having a substantial portion positioned above a waterline of the buoyant actuator when there is substantially no downward force restraining the buoyant actuator, wherein the one or more tanks have at least one upper opening in an upper region thereof, and at least one lower opening in a lower region thereof, the at least one upper opening and the at least one lower opening enabling the filling of the one or more tanks by the action of gravity when the one or more tanks are positioned below the fluid surface, while also enabling the draining of the one or more tanks by the action of gravity when the buoyant actuator rises to the fluid surface of the fluid body.

According to an eleventh aspect of the invention there is provided a wave energy conversion system comprising a buoyant actuator according to any one of the preceding aspects of the invention.

According to a twelfth aspect of the invention there is provided a buoyant actuator comprising a body presenting an exterior surface, the body being adapted to be continuously located below a fluid surface when in an operative state, the body being configured to provide one or more ballast tanks in an upper section thereof, wherein at least one of the one or more ballast tanks is capable of self-filling and self-draining.

According to a twelfth aspect of the invention there is provided a buoyant actuator comprising a body presenting an exterior surface, the body being adapted to be continuously located below a fluid surface when in an operative state, the body being configured to provide one or more ballast tanks, wherein at least one of the one or more ballast tanks is capable of self-filling and capable of at least partially self-draining.

Preferably when the buoyant actuator is floating at the surface of the fluid body with substantially no downward force restraining the buoyant actuator, any portions of the one or more ballast tanks that are positioned above the fluid surface are capable of self-draining by the action of gravity.

Preferably when a downward force is exerted on the buoyant actuator such that the buoyant actuator is in a position below the fluid surface, the one or more ballast tanks are capable of self-filling by the action of gravity.

Preferably the one or more ballast tanks has at least one upper opening in an uppermost region thereof.

Preferably the one or more ballast tanks has at least one lower opening positioned below the at least one upper opening when being transported or when in operation.

Preferably the at least one upper opening of the at least one first tank has a valve to regulate the flow of fluid through the at least one first tank, whereupon selective operation of the valve causes fluid to pass through the at least one upper opening, selectively enabling the at least one first tank to self-fill and self-drain based on the state of the valve and the position of the buoyant actuator relative to the fluid surface.

Preferably the at least one upper opening of the at least one first tank and the at least one lower opening of the at least one first tank each have a valve to regulate the flow of fluid through the at least one first tank, whereupon selective operation of the valve allows fluid to enter the at least one first tank when at least the lowermost region of the at least one first tank is below the fluid surface, and to drain from the at least one first tank when at least the uppermost region of the at least one first tank is above the fluid surface, such that the at least one first tank is capable of self-filling and self-draining by the action of gravity based on the state of each valve and the position of the buoyant actuator relative to the fluid surface.

### BRIEF DESCRIPTION OF THE DRAWINGS

Further features of the present invention are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying drawings in which:

FIG. 1 is a perspective view of a buoyant actuator according to a first embodiment of the present invention, the figure shows the buoyant actuator secured to the seabed with three angularly displaced tethers;

FIG. 2 is a perspective view of the buoyant actuator of FIG. 1;

FIG. 3 is a perspective view of the buoyant actuator of FIG. 1 without the upper surface shown;

FIG. 4 is a side view of the buoyant actuator of FIG. 3;

FIG. 5 is a sectional view of the interconnection between several tanks of the buoyant actuator of FIG. 1;

FIGS. 6, 7 and 8 are schematic representations of the buoyant actuator shown in FIG. 1 at various positions relative to the fluid surface;

FIG. 9 is a schematic representation of a buoyant actuator according to a second embodiment of the present invention, the buoyant actuator is located at a position relative to the fluid surface for transportation;

FIGS. 10a and 10b are schematic representations of a buoyant actuator according to a third embodiment of the present invention, the buoyant actuator is shown at two different positions relative to the fluid surface, an operation position and a survival position;

FIGS. 11a and 11b are schematic representations of a buoyant actuator according to a fourth embodiment of the present invention, the buoyant actuator is shown at two different positions relative to the fluid surface, an operation position and a survival position;

FIGS. 12a and 12b are schematic representations of a buoyant actuator according to a fifth embodiment of the present invention, the buoyant actuator is shown at two different positions relative to the fluid surface, an operation position and a survival position;

FIG. 13 is a schematic representation of a buoyant actuator according to a sixth embodiment of the present invention, the buoyant actuator is located at an operational position relative to the fluid surface for operation;

FIG. 14 is a schematic representation of a buoyant actuator according to a seventh embodiment of the present invention, the buoyant actuator is located at an operational position relative to the fluid surface for operation; and

FIG. 15 is a schematic representation of a buoyant actuator according to an eighth embodiment of the present invention.

In the drawings like structures are referred to by like numerals throughout the several views. The drawings shown are not necessarily to scale, with emphasis instead generally being placed upon illustrating the principles of the present invention.

### BEST MODE(S) FOR CARRYING OUT THE INVENTION

In one arrangement, a wave energy conversion assembly comprises a buoyant apparatus which may be configured as a buoyant actuator responsive to wave motion, and more particularly a buoyant actuator for coupling wave motion to a device operable in response to wave motion. In such an arrangement, the buoyant apparatus may be immersed in a body of water below the surface thereof.

The invention has been devised particularly, although not necessarily solely, as a buoyant actuator for harnessing wave energy and for converting the harnessed energy to motion for driving an energy conversion device. In such an arrangement, the actuator may be operably connected to the energy conversion device, with the buoyant actuator being buoyantly suspended within the body of water (but typically below the water surface). In this way, the buoyant actuator is, in effect, a submerged float which moves in response to wave action within the body of water.

The embodiments shown in the drawings are each directed to a wave energy conversion assembly 10 comprising a buoyant actuator 11 which assists in harnessing ocean wave energy.

Once placed in a fluid the buoyant actuator 11 can move between three distinct modes based on the position of the buoyant actuator 11 relative to a fluid surface of the fluid. The buoyant actuator 11 moves between a transportation state, an operation state and a survival state.

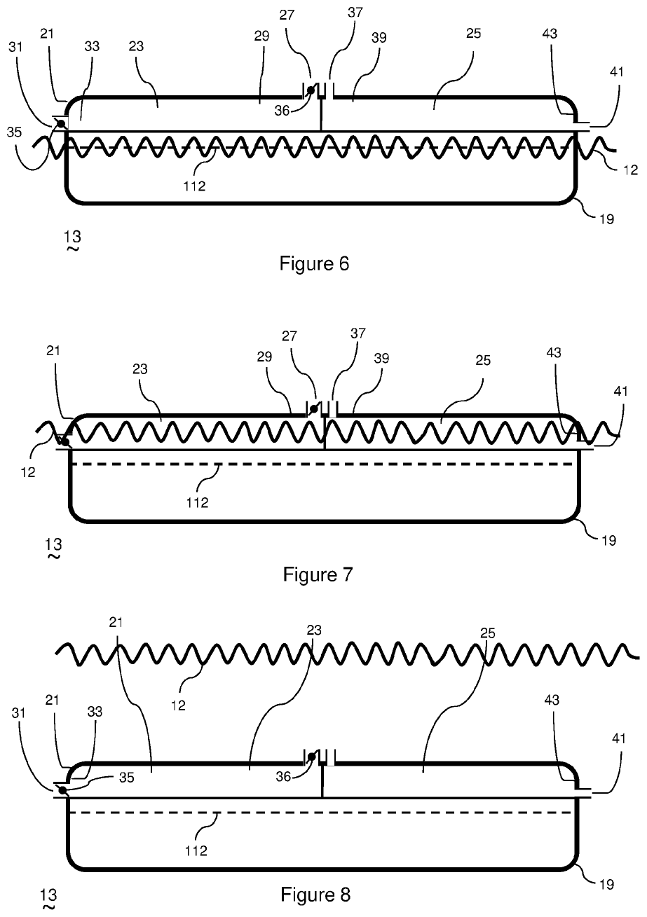

In the transportation state the buoyant actuator 11 is in a transportation position relative to the surface. The transportation position provides the most effective position when transporting the buoyant actuator 11 (without using other floatation means), or when otherwise maintaining the buoyant actuator 11 while in the fluid. When in the transportation position a waterline 112 of the buoyant actuator 11 aligns with the fluid surface (see for example FIGS. 6, 7 and 8). The waterline 112 is a reference datum line and is determined by the natural/inherent buoyancy of the of the buoyant actuator 11.

In the operation state the buoyant actuator 11 is in an operational position below the fluid surface. Typically when in the operational position the entire buoyant actuator 11 is submerged.

In the survival state the buoyant actuator 11 is in a survival position. The survival position is below the operational position. When in the survival position the entire buoyant actuator 11 is submerged at a depth less affected by conditions at the fluid surface, such as those caused by a storm.

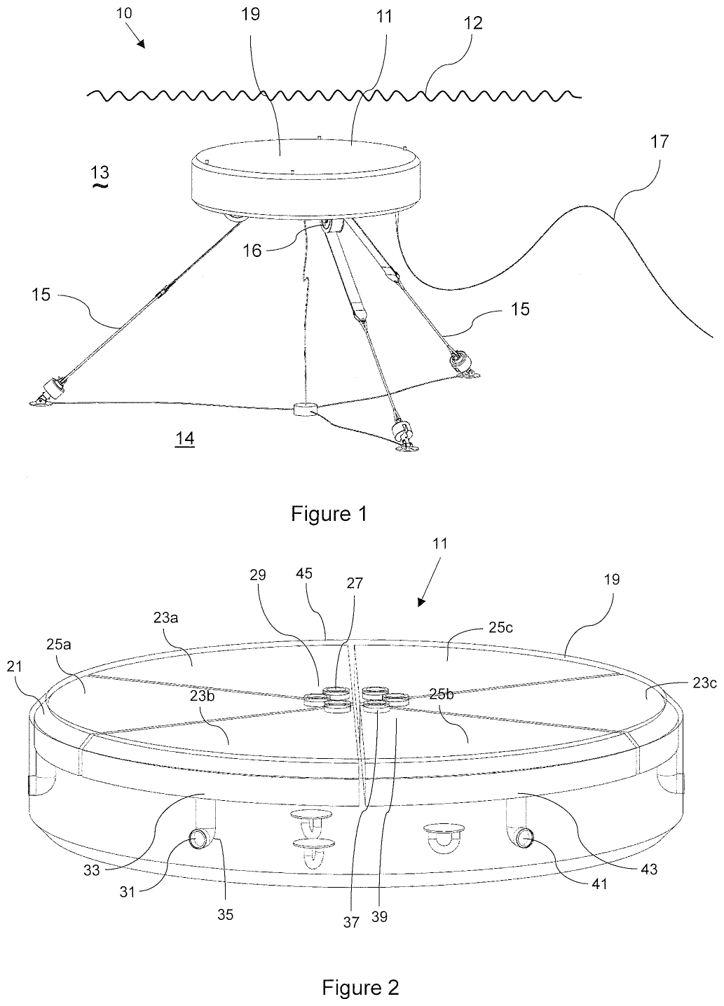

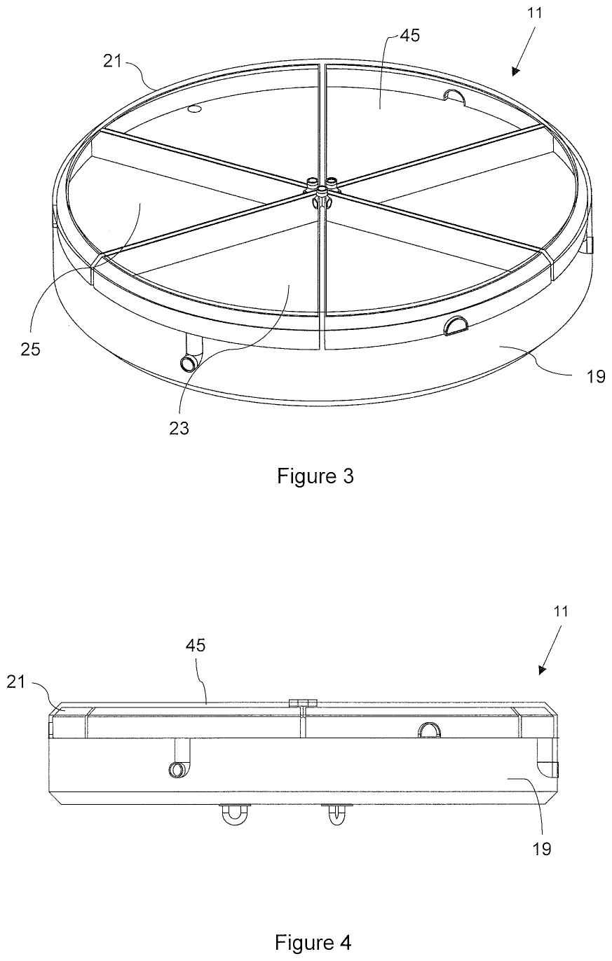

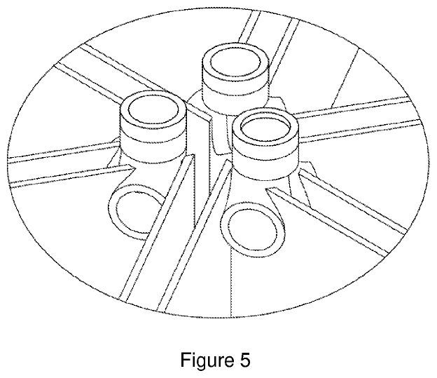

Referring to FIG. 1, the buoyant actuator 11 is installed offshore in a fluid, typically a body of water 13, such as the ocean, having a fluid surface 12 and a seabed 14. The buoyant actuator 11 is secured to the seabed by an anchoring means in the form of three tethers 15, and has a coupling means in the form of a cable 17 through which communications and power can travel. The buoyant actuator 11 also comprises a wave motion conversion device 16 extending between the buoyant actuator 11 and the tethers 15.

The buoyant actuator 11 comprises a body 19 which is adapted to be located below the fluid surface 12 when in its operational position. The body 19 provides a plurality of ballast tanks in the form of a set of first tanks 23 and a set of second tanks 25.

An upper portion 21 of the body 19 provides three first tanks 23a, 23b, 23c and three second tanks 25a, 25b, 25c. The tanks are positioned such that the upper portion 21 of the body is located above, or close to the fluid surface 12 when each of the first tanks 23 and second tanks 25 are substantially empty and no other downward force is exerted thereon, such as force from the tethers. In this position the waterline 112 of the buoyant actuator 11 aligns with the fluid surface 12.

Each first tank 23 has an upper opening 27 in an upper region 29, and a lower opening 31 located in a lower region 33. In this embodiment each lower opening 31 has a valve 35 and each upper opening 27 has a valve 36 to regulate the flow of fluid through each first tank 23, wherein selective operation of the valves 35, 36 cause fluid to pass through each upper opening 27, each first tank 23 and the lower opening 31.

Each second tank 25 has an upper opening 37 in an upper region 39, and a lower opening 41 located in a lower region 43. Each opening 37, 41 is permanently open such that as the buoyant actuator 11 is repositioned relative to the fluid surface 12 the fluid is able to freely pass through the upper opening 37, the second tank 25 and the lower opening 41.

While only one opening is shown, a person skilled in the art will readily understand that there may be more than one of each opening associated with each first tank and each second tank.

In variations of the invention the upper openings and the lower openings may be provided by perforations located in the body, existing openings, or due to imperfect sealing of the buoyant actuator's components.

An outer section 45 of the tanks is provided by the external surface of the body.

Positioning of the buoyant actuator 11 will now be discussed with reference to FIGS. 6 to 8. At the beginning and end of its life the buoyant actuator 11 is typically towed using a tug, barge or other similar watercraft. When transporting the buoyant actuator 11 it is desirable to have as much of the buoyant actuator 11 out of the water as possible. Similarly, once installed, if requiring to repair or modify the buoyant actuator 11 it is desirable to have as much of the buoyant actuator 11 out of the water as possible. To facilitate this requirement as much of the water as possible needs to be drained from the tanks 23, 25.

In the present embodiment, when the buoyant actuator 11 is in its operational position but requires repair or requires to be transported to a different location, the buoyant actuator 11 is desirably returned to its transportation position. When the buoyant actuator 11 of the present embodiment is in its operational position each first tank 23 is substantially empty, while each second tank 25 is full. To initiate the buoyant actuator 11 returning to its transportation position the buoyant actuator 11 is raised, either by untethering the buoyant actuator 11, or extending the length of the tethers 15. As the buoyant actuator 11 rises and reaches the surface 12, the fluid in each second tank 25 is free to exit each second tank 25 through the permanently open lower openings 41. As more fluid exits each second tank 25, the buoyant actuator 11 continues to rise until it reaches a point where each second tank 25 is above the waterline and is substantially empty. With this configuration the second tank 25 is self-draining. In this regard each second tank 25 does not require any additional infrastructure or equipment, such as a pump, in order to drain fluid from the tank. Each second tank 25 will begin emptying as the fluid naturally seeks to flow to the lowest point.

As both the lower opening 41 and upper opening 37 of each second tank 25 are permanently open, the volume of fluid in each second tank 25 varies directly with changes in the position of the buoyant actuator 11 relative to the fluid surface 12. As the buoyant actuator 11 rises and reaches the surface 12, the fluid in each second tank 25 is free to exit each second tank 25 through the permanently open lower opening 41. Fluid will continue to drain from each second tank 25 until the waterline 112 of the buoyant actuator 11 substantially aligns with the fluid surface 12. As more fluid exits each second tank 25 the buoyant actuator 11 continues to rise until it reaches its transportation position. With this configuration each second tank 25 is self-draining, negating the need for a pump and associated equipment.

In the process of raising the buoyant actuator 11 from its survival position and readying it for transportation or repair, the valve 35 associated with the lower opening 31 of each first tank 23 and the valve 36 associated with the upper opening 27 of each first tank 23 can be selectively opened, allowing the fluid in each first tank 23 to exit the first tank 23 through open lower opening 31. The volume of fluid in each first tank 23 varies directly with changes in the position of the buoyant actuator 11 relative to the fluid surface 12. Once the valves 35, 36 associated with each first tank 23 are open, each first tank 23 becomes self-draining. In this regard each first tank 23 is capable of self-draining. Once the valves 35, 36 are open each first tank 23 is able to self-drain without any additional infrastructure or equipment, such as a pump, in order to remove fluid from each first tank 23. Each first tank 23 will begin emptying as the fluid naturally seeks to flow to the lowest point.

In the present embodiment each first tank 23 and each second tank 25 is positioned above the waterline 112 of the buoyant actuator 11. With this arrangement it would be expected that each first tank 23 and each second tank 25 is able to drain the fluid therefrom to a point at which each first tank 23 and each second tank 25 is substantially empty. Naturally other embodiments are envisaged where this is not the case. The configuration of each first tank and each second tank and its relation to the waterline will determine how much fluid drains from each first tank and each second tank when the buoyant actuator 11 is in its transportation position.

In those embodiments where one or more of each first tank and/or each second tank has a portion located below the waterline of the buoyant actuator 11, the fluid in those tanks will drain to the waterline as the buoyant actuator 11 moves to its transportation position.

The degree of draining of each tank when the buoyant actuator 11 is in its transportation position will depend on the orientation of each tank relative to the waterline.

It is envisaged that one or more of each first tank and/or each second tank are not identical in shape, position and/or size and may have a portion located below the waterline of the buoyant actuator. This may be due to the internal configuration of the buoyant actuator 11.

For example, there are embodiments where the buoyant actuator 11 has one or more first tanks located above the waterline, and one or more second tanks with a portion located below the waterline of the buoyant actuator. In these circumstances, when the buoyant actuator 11 is in its transportation position, nearly all the fluid will drain from the one or more first tanks, while the fluid in the one or more second tanks will drain to the waterline (which aligns with the fluid surface when the buoyant actuator is in the transportation position).

Furthermore, as the buoyant actuator 11 operates in an unstable environment (e.g. an ocean) it would be expected that some fluid would remain in each tank when the buoyant actuator 11 is in its transportation position, even in those cases the entirety of each tank is located above the waterline 112.

As each first tank 23 and second tank 25 empties, the buoyant actuator 11 continues to rise, and the fluid progressively exits the first tank 23 and the second tank 25. Upon the fluid draining from each first tank 23 and each second tank 25, the portion of the body of the buoyant actuator 11 above the fluid surface is at its maximum, and the buoyant actuator 11 has reached its transportation position. When in the transportation position the buoyant actuator 11 can be transported efficiently.

A similar sequence of events takes place to return the buoyant actuator 11 to the surface 12 when the buoyant actuator 11 is in its survival position (i.e. when each of the first tanks 23 and each of the second tanks 25 are full), and needs to be reset before being returned to its operational position (i.e. when each of the first tanks 23 is substantially empty and each of the second tanks 25 is full).

This process can be achieved in an acceptably short period of time.

Once the buoyant actuator 11 has been transported to its operational site, or repairs have been completed, the buoyant actuator 11 must transition from the transportation position to its operating position below the fluid surface 12. In the present embodiment this can be initiated by lowering the buoyant actuator 11 by retracting the tethers 15 (once connected to the buoyant actuator 11). As the buoyant actuator 11 descends below the fluid surface 12, fluid is free to enter each second tank 25 through the permanently open lower opening 41. As more fluid enters each second tank 25 the buoyant actuator 11 continues to descend until it reaches a point where the second tank 25 is full. With this configuration the second tank 25 is self-filling, negating the need for a pump and/or other associated equipment.

As each lower opening 41 and each upper opening 37 of each second tank 25 are permanently open, the volume of fluid in each second tank 25 is able to vary directly with changes in the position of the buoyant actuator 11 relative to the fluid surface 12. Upon the buoyant actuator 11 becoming completely submerged each second tank 25 is full (or is in the process of filling).

As the buoyant actuator 11 descends from the surface 12, fluid is free to enter each second tank 25 through the permanently open lower opening 41. As more fluid enters each second tank 25 the buoyant actuator 11 continues to descend until it reaches a point where each second tank 25 is full. With this configuration each second tank 25 is self-filling, negating the need for a pump and/or associated equipment.

In the process of lowering the buoyant actuator 11 and readying it for operation, the valves 35, 36 associated with the lower openings 31 and the upper openings 27 of each first tank 23 are retained in a closed position, preventing the fluid from entering each first tank 23 through either the upper opening 27 or the lower opening 31.

The volume of fluid in each first tank 23 varies directly with changes in the position of the buoyant actuator 11 relative to the fluid surface but only upon the valves 35, 36 opening. When the valves 35, 36 are open each first tank 23 becomes self-filling. Each first tank 23 is capable of self-filling. Once the valves 35, 36 are open each first tank 23 is able to self-fill without any additional infrastructure or equipment, such as a pump, in order to fill the tank substantially with fluid.

The buoyant actuator 11 can now commence operations. This process can be achieved in an acceptably short period of time.

When the buoyant actuator 11 is exposed to extreme sea states, it is desirable to increase the operating depth of the buoyant actuator 11 as it is known that wave excitation forces decrease significantly with increasing operating depth. This mode is also be referred to as the “survival mode”. This is initiated by lowering the buoyant actuator 11 by retracting the tethers 15. As the buoyant actuator 11 descends, the angle of the tethers increases, necessitating a greater tether force (to counter the buoyancy of the buoyant actuator) the further the buoyant actuator 11 descends. To alleviate the need for an increase in the tether force, the valve 35 associated with the lower opening 31 and the valve 36 associated with the upper opening 27 of each first tank 23 is selectively opened, allowing the fluid to enter each first tank 23 through the lower opening 31. The volume of fluid in each first tank 23 varies directly with how long the valves 35, 36 remain open. In the given circumstances, the valves 35, 36 would be expected to remain open while the buoyant actuator 11 is submerged. Once the valves 35, 36 of each first tank 23 are open, the first tank 23 becomes self-filling.

As the first tank 23 fills, the buoyant actuator 11 is able to continue to descend without the need for additional tether forces, until the first tank 23 is full. Once in the full condition, and without adding additional components to the buoyant actuator 11, the buoyant actuator 11 is at its heaviest.

As each first tank 23 and each second tank 25 are full, rendering the buoyant actuator 11 at its heaviest, the required tether forces are reduced compared to a buoyant actuator without this configuration.

To facilitate self-draining of each first tank 23, the body 19 returns to the fluid surface 12. This is preferably when transitioning the buoyant actuator 11 from its survival position to its operational position.

During installation the second tank will self-fill as the buoyant actuator is pulled below the fluid surface via retracting tethers, in reverse, the second tank will self-drain once the buoyant actuator reaches the surface when the tethers are wound out. To activate the survival mode during operation, the valves 35 and 36 are opened allowing the first tank to fill. To drain the first tank, the buoyant actuator 11 surfaces, and the valves 35 and 36 remain open. The first tank will then self-drain.

The present invention provides the simplicity of self-filling and draining first and second tanks, be that for transport to or from the installation site, installation, during operation, or for activation/cancellation of survival mode.

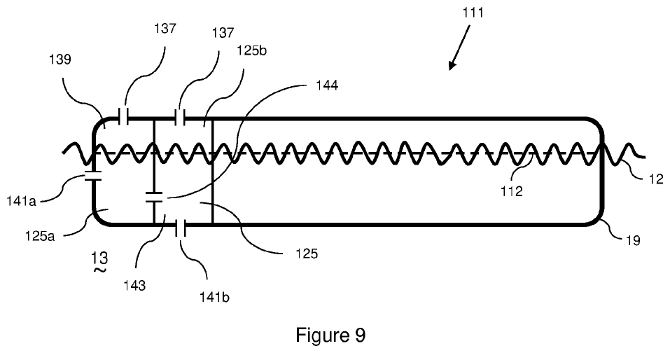

A buoyant actuator 111 according to a second embodiment of the invention is illustrated in FIG. 9. For convenience features of the buoyant actuator 111 that are similar or correspond to features of the buoyant actuator 11 of the first embodiment have been referenced with the same reference numerals.

In this embodiment the buoyant actuator 111 has a body 19 comprising a plurality of second tanks 125. While only two are shown in FIG. 9 it is to be understood that more than two may be present. In addition the second tanks 125 are represented schematically and can take a variety of shapes and configurations.

Each second tank 125a, 125b is orientated such that a longitudinal axis thereof is angled relative to the longitudinal axis of the body 19. In FIG. 9 each second tank 125a, 125b extends across the width of the body 19. This is for illustration purposes only, noting that each second tank 125a, 125b could take different configurations. Each second tank 125a, 125b has an upper opening 137 in an upper region 139, and a lower opening 141a, 141b located in a lower region 143. Each opening 137, 141 is permanently open such that as the buoyant actuator 111 is repositioned relative to the fluid surface 12 the fluid is able to freely pass through the upper opening 137, the second tank 125 and the lower opening 141.

The second tanks 125a, 125b have a channel 144 therebetween to allow for fluid movement between the two second tanks 125. In other variations there may be a number of channels or similar, and these may be fitted with non-return valves.

In this embodiment the lower opening 141a of the second tank 125a extends through the side of the body 19. With this configuration the lower opening 141a dictates the maximum level to which the second tanks 125 can empty (when the lower opening 141a is positioned above the waterline of the buoyant actuator 111). It is expected that in most applications all openings 141 will be at or very near the bottom of each second tank 125.

The operation of the buoyant t actuator 111 between its operation/survival positions and the transportation position is similar to the operation of the second tanks 25 described above in relation to the buoyant actuator 11 of the first embodiment. In particular the second tanks 125 of the buoyant actuator 111 are self-filling and self-draining. While each second tank 125 would be expected to fill to or near capacity, the degree of self-draining when the buoyant actuator 111 is in its transportation position will depend on the orientation of each second tank 25 relative to the waterline.

In a variation of the buoyant actuator 111 of the second embodiment, the body 19 may comprise first tanks similar to the second tanks 125 wherein the outlets are fitted with valves, and operate in a similar manner as described above in relation to the buoyant actuator 11 of the first embodiment.

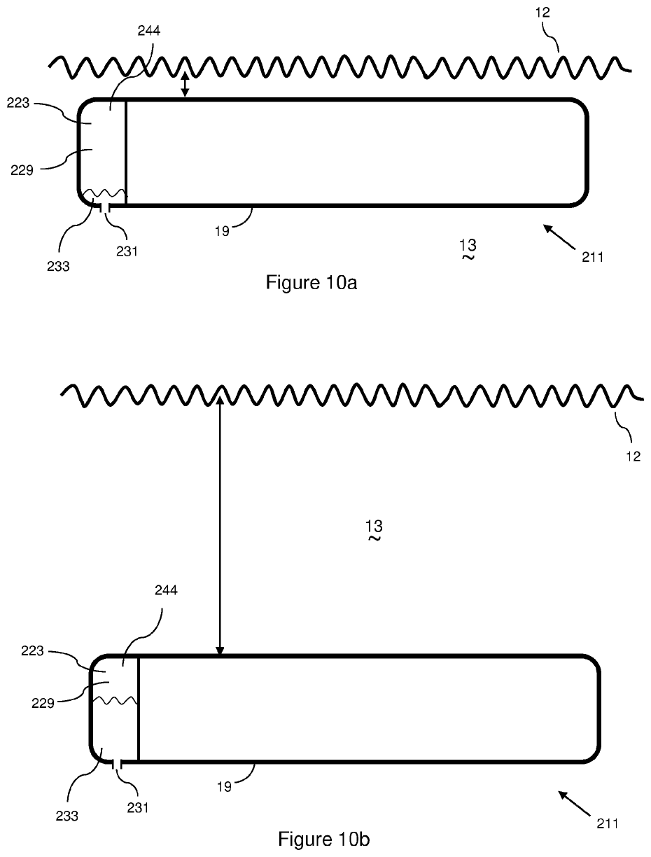

A buoyant actuator 211 according to a third embodiment of the invention is illustrated in FIGS. 10a, 10b. For convenience features of the buoyant actuator 211 that are similar or correspond to features of the buoyant actuator 11 of the first embodiment have been referenced with the same reference numerals.

In this embodiment the buoyant actuator 211 has a body 19 comprising a plurality of first tanks 223. While only one is shown in FIGS. 10a, 10b it is to be understood that more than one may be present. In addition the first tank 223 is represented schematically and can take a variety of shapes and configurations, being formed to take advantage of the configuration of the body 19.

Each first tank 223 is orientated such that a longitudinal axis thereof is angled relative to the longitudinal axis of the body 19. In FIGS. 10a, 10b the first tank 223 extends across the width of the body 19. This is for illustration purposes only, noting that the first tank 223 could take different configurations. Each first tank 223 has a lower opening 231 located in a lower region 233. Each lower opening 231 is permanently open such that when the buoyant actuator 211 is placed in the fluid a pocket of air 244 is formed and trapped in an upper region 229 of the first tank 223. As represented in FIG. 10b, the size of the air pocket 244 is affected by the depth of the buoyant actuator 211 below the fluid surface 12. The deeper the buoyant actuator 211 descends the smaller the air pocket 244 and the greater is the mass of fluid which enters the buoyant actuator 211. This decreases the downward force the tethers 15 will need to apply to cause the buoyant actuator 211 to descend, such as when the buoyant actuator 211 is moved to the survival position.

When the buoyant actuator 211 ascends the air pocket 244 is able to expand, pushing water from the first tank 223 through the lower opening 231. This adds buoyancy to the buoyant actuator 211. In contrast to the buoyant actuator 11 of the first embodiment, the buoyant actuator 211 does not require to return to the surface to reset the first tank 223 when moving between the survival position and the operation position.

In a variation of the buoyant actuator 211 of the third embodiment the body 19 may comprise second tanks similar to the second tanks of the first and/or second embodiments.

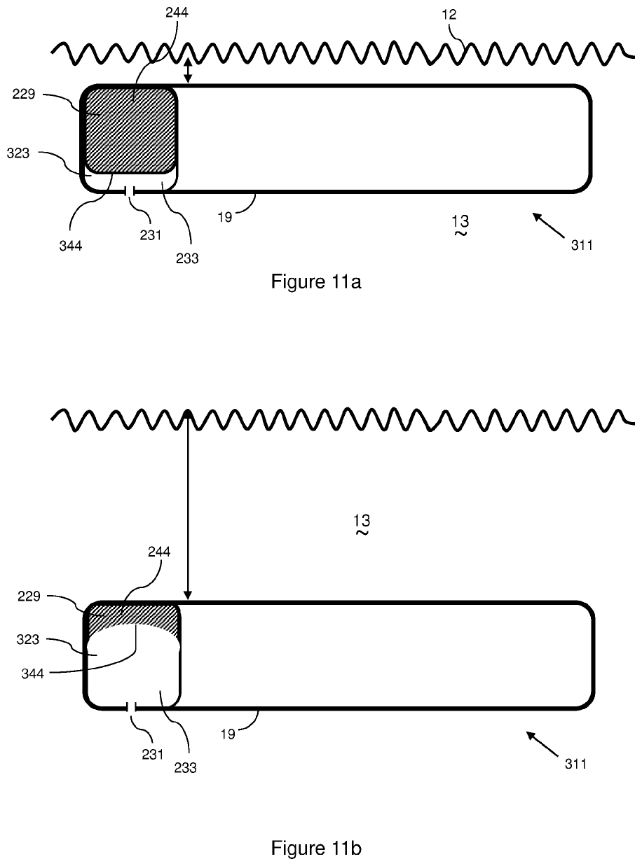

A buoyant actuator 311 according to a fourth embodiment of the invention is illustrated in FIGS. 11a, 11b. For convenience features of the buoyant actuator 311 that are similar or correspond to features of the buoyant actuator 11 of the first embodiment and features of the buoyant actuator 211 of the third embodiment have been referenced with the same reference numerals.

Similar to the buoyant actuator 211 of the third embodiment, in this embodiment the buoyant actuator 311 has a body 19 comprising a plurality of first tanks 323. While only one is shown in FIGS. 11a, 11b it is to be understood that more than one may be present. In addition the first tank 323 is represented schematically and can take a variety of shapes and configurations, being formed to take advantage of the configuration of the body 19.

The significant difference between the buoyant actuator 311 of this fourth embodiment and the buoyant actuator 211 of the third embodiment is the presence of a compressible medium in the form of a flexible membrane 344 separating the air pocket 244 from the fluid which is present in the lower region 233 of the first tank 323. The flexible membrane 344 ensures that the air pocket 244 is not depleted over time.

The operation of the first tank 323 of the buoyant actuator 311 of this fourth embodiment is otherwise the same as described with respect to the buoyant actuator 211 of the third embodiment.

In a variation of the buoyant actuator 311 of the fourth embodiment the body 19 may comprise second tanks similar to the second tanks of the first and/or second embodiments.

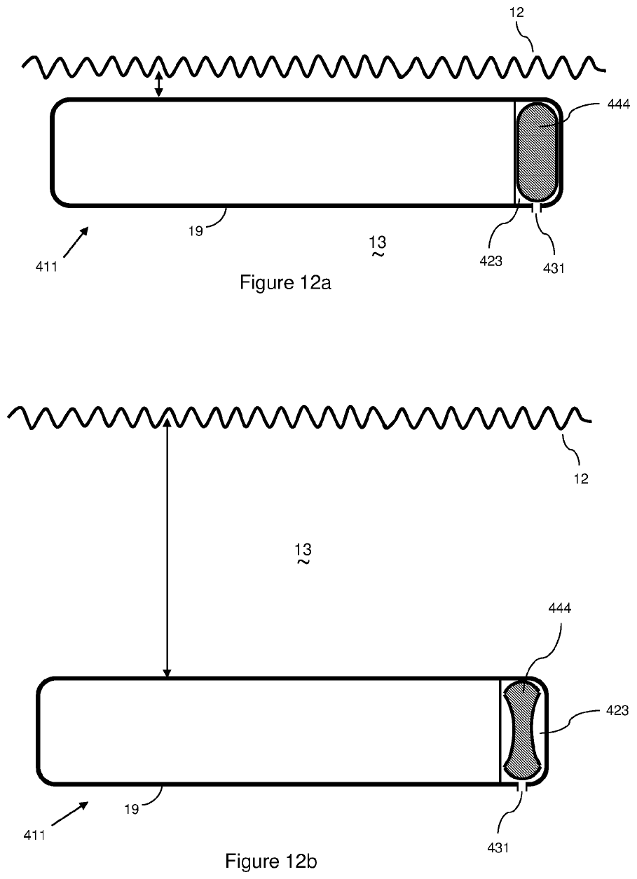

A buoyant actuator 411 according to a fifth embodiment of the invention is illustrated in FIGS. 12a, 12b. For convenience features of the buoyant actuator 411 that are similar or correspond to features of the buoyant actuator 11 of the first embodiment and features of the buoyant actuator 211 of the third embodiment have been referenced with the same reference numerals.

Similar to the buoyant actuator 211 of the third embodiment, in this embodiment the buoyant actuator 411 has a body 19 comprising a plurality of first tanks 423. While only one is shown in FIGS. 12a, 12b it is to be understood that more than one may be present. In addition the first tank 423 is represented schematically and can take a variety of shapes and configurations, being formed to take advantage of the configuration of the body 19.

The significant difference between the buoyant actuator 411 of this fifth embodiment and the buoyant actuator 211 of the third embodiment is the presence of a compressible member in the form of an inflatable elastic body 444. The inflatable elastic body 444 is sealed, providing a pocket of air, or similar, therein.

The operation of the first tank 423 of the buoyant actuator 411 of this fourth embodiment is similar to that described with respect to the buoyant actuator 211 of the third embodiment. In this embodiment rather than the air pocket 244 shrinking, the inflatable elastic body 444 progressively collapses, as shown in FIG. 12b, allowing more fluid to enter the first tank 423. The inflatable elastic body 444 may be pressurised during installation such that it resists collapsing until a predetermined depth is reached.

In a variation of the buoyant actuator 411 of the fifth embodiment the body 19 may comprise second tanks similar to the second tanks of the first and/or second embodiments.

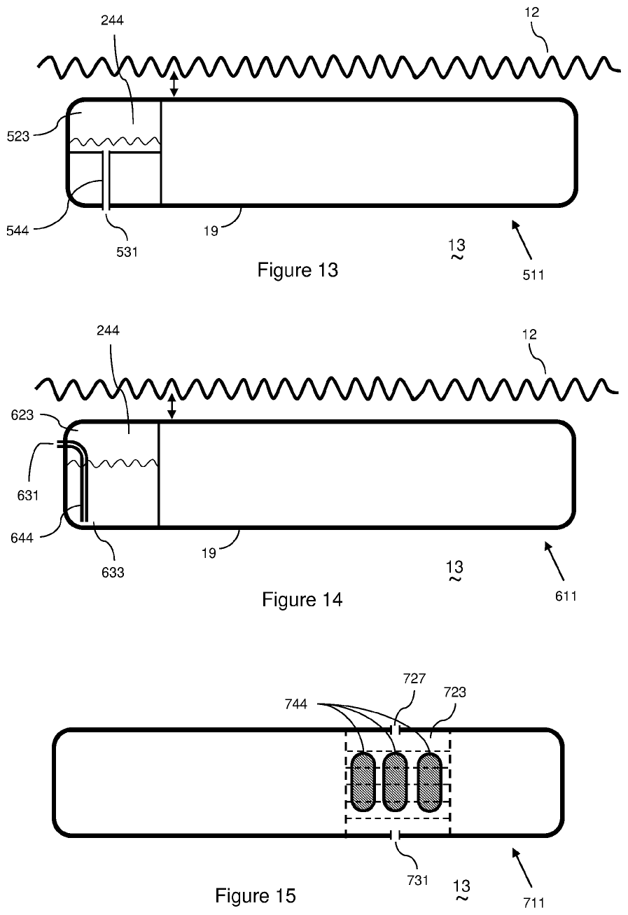

A buoyant actuator 511 according to a sixth embodiment of the invention is illustrated in FIG. 13. For convenience features of the buoyant actuator 511 that are similar or correspond to features of the buoyant actuator 11 of the first embodiment and features of the buoyant actuator 211 of the third embodiment have been referenced with the same reference numerals.

Similar to the buoyant actuator 211 of the third embodiment, in this embodiment the buoyant actuator 511 has a body 19 comprising a plurality of first tanks 523. While only one is shown in FIG. 13 it is to be understood that more than one may be present. In addition the first tank 523 is represented schematically and can take a variety of shapes and configurations, being formed to take advantage of the configuration of the body 19.

The significant difference between the buoyant actuator 511 of this sixth embodiment and the buoyant actuator 211 of the third embodiment is the presence of an elongated passage 544 that connects the first tank 523 with the lower opening 531 and connects the tank 523 with the environment external to the body 19. This configuration mitigates the risk of air contained in tank 523 escaping from the tank 523.

The operation of the first tank 523 of the buoyant actuator 511 of this sixth embodiment is otherwise the same as described with respect to the buoyant actuator 211 of the third embodiment.

In a variation of the buoyant actuator 511 of the sixth embodiment, the body 19 may comprise second tanks similar to the second tanks of the first and/or second embodiments.

A buoyant actuator 611 according to a seventh embodiment of the invention is illustrated in FIG. 14. For convenience features of the buoyant actuator 611 that are similar or correspond to features of the buoyant actuator 11 of the first embodiment and features of the buoyant actuator 211 of the third embodiment have been referenced with the same reference numerals.

Similar to the buoyant actuator 211 of the third embodiment, in this embodiment the buoyant actuator 611 has a body 19 comprising a plurality of first tanks 623. While only one is shown in FIG. 14 it is to be understood that more than one may be present. In addition the first tank 623 is represented schematically and can take a variety of shapes and configurations, being formed to take advantage of the configuration of the body 19.

The significant difference between the buoyant actuator 611 of this seventh embodiment and the buoyant actuator 211 of the third embodiment is the location of an opening 631 of the first tank 623. In this embodiment the opening 631 is in a side of the first tank 623 adjacent the air pocket 244. The first tank 623 incorporates a passage 644 which passes from the opening 631, terminating in the fluid at a lower region 633 of the first tank 623. As a result the opening 631 of the first tank 623 is in direct fluid communication with the fluid in the lower region 633 of the first tank 623.

The operation of the first tank 623 of the buoyant actuator 611 of this seventh embodiment is otherwise the same as described with respect to the buoyant actuator 211 of the third embodiment.

In a variation of the buoyant actuator 611 of the seventh embodiment, the body 19 may comprise second tanks similar to the second tanks of the first and/or second embodiments.

A buoyant actuator 711 according to an eighth embodiment of the invention is illustrated in FIG. 15. For convenience features of the buoyant actuator 711 that are similar or correspond to features of the buoyant actuator 11 of the first embodiment and features of the buoyant actuator 411 of the fifth embodiment have been referenced with the same reference numerals.

Similar to the buoyant actuator 411 of the fifth embodiment, in this embodiment the buoyant actuator 711 has a body 19 comprising a plurality of first tanks 723. While only one is shown in FIG. 15 it is to be understood that more than one may be present. In addition the first tank 723 is represented schematically and can take a variety of shapes and configurations, being formed to take advantage of the configuration of the body 19.

The significant difference between the buoyant actuator 711 of this eighth embodiment and the buoyant actuator 411 of the fifth embodiment is that the compressible member is provided in the form of a plurality of compressible devices 744. The first tank 723 may be a compartment exposed to the ambient fluid pressure whereby the compressible devices 744 are restrained within a cage or similar within the compartment. In the present embodiment the first tank 723 has an upper opening 727 and a lower opening 731, however in other variations these openings may be located anywhere relative to the first tank 723.

The operation of the first tank 723 of the buoyant actuator 711 of this eighth embodiment is similar to that described with respect to the buoyant actuator 411 of the fifth embodiment. In this embodiment each compressible device 744 progressively collapses, as the buoyant actuator 711 descends from a predetermined depth, allowing more water to enter the first tank 723.

In a variation of the buoyant actuator 711 of the eighth embodiment the body 19 may comprise second tanks similar to the second tanks of the first and/or second embodiments.

In a variation to the fourth, fifth and seventh embodiments (not shown), the respective compressible devices (344, 444, 744) may be positioned to be situated below the fluid surface when the buoyant actuator is in the transport state, such that said compressible devices contribute their full buoyancy to the buoyant actuator for maintenance and transport purposes.

In further embodiments, a buoyant actuator may comprise a body providing a combination of first tanks and/or second tanks as described herein.

As would be readily understood by the person skilled in the art, in order for the present system to convert wave motion to energy, the buoyant actuator is positively buoyant, regardless of whether the tanks of the buoyant actuator are full, empty or therebetween.

Modifications and variations such as would be apparent to the skilled addressee are considered to fall within the scope of the present invention. The present invention is not to be limited in scope by any of the specific embodiments described herein. These embodiments are intended for the purpose of exemplification only. Functionally equivalent products, formulations and methods are clearly within the scope of the invention as described herein. It will be understood by those skilled in the art that various changes in form and details may be made therein without departing from the spirit and scope of the invention as defined by the appended claims.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Such variations are not to be regarded as a departure from the disclosure, and all such modifications are intended to be included within the scope of the disclosure. Reference to positional descriptions and spatially relative terms), such as “inner,” “outer,” “beneath”, “below”, “lower”, “above”, “upper” and the like, are to be taken in context of the embodiments depicted in the figures, and are not to be taken as limiting the invention to the literal interpretation of the term but rather as would be understood by the skilled addressee.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

It will be understood that when an element is referred to as being “on”, “engaged”, “connected” or “coupled” to another element/layer, it may be directly on, engaged, connected or coupled to the other element/layer or intervening elements/layers may be present. Other words used to describe the relationship between elements/layers should be interpreted in a like fashion (e.g., “between”, “adjacent”). As used herein the term “and/or” includes any and all combinations of one or more of the associated listed items.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprise”, “comprises,” “comprising,” “including,” and “having,” or variations thereof are inclusive and therefore specify the presence of stated features, integers, steps, operations, elements, and/or components, but do not preclude the presence or addition of one or more other features, integers, steps, operations, elements, components, and/or groups thereof.

1-66. (canceled)

67. A buoyant actuator comprising:
a body presenting an exterior surface, the body being adapted to be continuously located below a fluid surface during operation,
the body providing at least one tank in an upper portion of the body, the at least one tank having at least one opening in an upper portion, and at least one opening in a lower portion, such that fluid can pass through the openings of the at least one tank as the buoyant actuator is repositioned relative to the fluid surface;
whereby when the buoyant actuator has no external downward force acting thereon an upper portion of the body is located above the fluid surface and thus allows a volume of the at least one tank above a waterline of the buoyant actuator to drain by the action of gravity.

68. The buoyant actuator according to claim 67 wherein at least one opening in an upper portion and at least one opening in a lower portion are permanently open.

69. The buoyant actuator according to claim 67 wherein the at least one upper opening of the at least one tank has a valve to regulate the flow of fluid through the at least one tank, whereupon selective operation of the valve causes fluid to pass through the at least one upper opening, selectively enabling the at least one tank to self-fill and self-drain by the action of gravity based on the state of the valve and the position of the buoyant actuator relative to the fluid surface.

70. The buoyant actuator according to claim 69 wherein the at least one lower opening of the at least one tank has a valve to regulate the flow of fluid through the at least one tank, whereupon selective operation of the valve causes fluid to pass through the at least one lower opening, selectively enabling the at least one tank to self-fill and self-drain by the action of gravity based on the state of the valve and the position of the buoyant actuator relative to the fluid surface.

71. The buoyant actuator according to claim 67 wherein the body provides a plurality of tanks, wherein one or more of the plurality of tanks have an opening therebetween.

72. The buoyant actuator according to claim 67, wherein at least one tank either is formed from or incorporates a compressible medium wherein the compressible medium is exposed to the pressure of the fluid entering the at least one tank.

73. The buoyant actuator according to claim 72 wherein the compressible medium is pre-pressurised.

74. The buoyant actuator according to claim 72 wherein the compressible medium is selected from or is a combination of: a sealed bladder, a compressible foam, a flexible membrane dividing the tank, or a combination of each.

75. The buoyant actuator according to claim 67 wherein the buoyant actuator comprises or is coupled to one or more tethers which are adapted to secure the buoyant actuator to the seabed or other structure.

76. The buoyant actuator according to claim 75 wherein the one or more tethers are retracted or extended relative to the body to change the depth at which the body is positioned in the fluid body.

77. The buoyant actuator according to claim 75 wherein the buoyant actuator is configured to maintain a substantially taut connection between the body and the tether regardless of whether any tank is full, empty, or partially full.

78. The buoyant actuator according to claim 67 wherein the body of the buoyant actuator is associated with an anchoring means for operatively connecting the buoyant actuator relative to the seabed, or other permanent structure.

79. The buoyant actuator according to claim 78 wherein the anchoring means is in the form of one or more tethers extending partially or entirely between the buoyant actuator and the seabed or other permanent structure.

80. The buoyant actuator according to claim 79 wherein the one or more tethers are connected to an energy conversion device which is connected to the body.

81. The buoyant actuator according to claim 67 wherein the buoyant actuator is associated with a coupling means, the coupling means incorporates an energy conversion device.

82. The buoyant actuator according to claim 67 wherein the body of the buoyant actuator is associated with a coupling means for operatively connecting the buoyant actuator to an energy conversion device.

83. A wave energy conversion system comprising a buoyant actuator according to claim 67.

84. A buoyant actuator comprising:
a body presenting an exterior surface, the body being adapted to be continuously located below a fluid surface during operation,
the body providing at least one first tank in an upper portion of the body, the at least one first tank having at least one opening in an upper portion, and at least one opening in a lower portion, such that fluid can pass through the openings and the at least one first tank as the buoyant actuator is repositioned relative to the fluid surface;
whereby when the buoyant actuator has no external downward force acting thereon an upper portion of the body is located above the fluid surface and thus allows a volume of the at least one first tank above a waterline of the buoyant actuator to drain by the action of gravity.

85. The buoyant actuator according to claim 84, comprising at least one second tank in an upper portion of the body, the at least one second tank having at least one opening in an upper portion, and at least one opening in a lower portion, wherein each of the upper opening or both of the upper opening and the lower opening of the at least one second tank has a valve to regulate the flow of fluid through the openings, whereas the at least one second tank remains empty when positioned below the fluid surface with the valve closed.

86. A buoyant actuator comprising:
a hollow body presenting an exterior surface, the hollow body being adapted to be continuously located below a fluid surface during operation,
the hollow body providing a tank, the tank having at least one opening in an upper portion, and at least one opening in a lower portion, wherein both openings of the tank are permanently open such that fluid can pass through the openings and the tank as the buoyant actuator is repositioned relative to the fluid surface;
whereby when the buoyant actuator has no external downward force acting thereon an upper portion of the body is located above the fluid surface and a volume of the at least one tank above a waterline of the buoyant actuator are empty;
an anchoring means associated with the hollow body for operatively connecting the buoyant actuator relative to the seabed, or other permanent structure.
